(19) United States
(12) Patent Application Publication
(10) Pub. No.: US 2014/0152543 A1
(43) Pub. Date: Jun. 5, 2014

(54) SYSTEM, DATA PROVIDING METHOD AND ELECTRONIC APPARATUS

(71) Applicant: KABUSHIKI KAISHA TOSHIBA, Tokyo (JP)

(72) Inventor: Hirotada Hirabayashi, Hamura-shi (JP)

(73) Assignee: Kabushiki Kaisha Toshiba, Tokyo (JP)

(21) Appl. No.: 13/764,480

(22) Filed: Feb. 11, 2013

(30) Foreign Application Priority Data
Nov. 30, 2012 (JP) 2012-262298

(51) Int. Cl. G06F 3/03

(52) U.S. Cl. CPC G06F 3/03
USPC 345/156

(57) ABSTRACT

According to one embodiment, a system includes a receiver, a controller, and a transmitter. The receiver receives a plurality of stroke data, which correspond to a plurality of strokes handwritten on first contents in a plurality of terminals, from the plurality of terminals. The controller stores the plurality of stroke data in a storage medium, the plurality of stroke data associated with an identifier of a terminal which is a sender. The transmitter transmits to a first terminal of the plurality of terminals one or more first stroke data of the plurality of stroke data. The one or more first stroke data are stroke data associated with an identifier of a terminal other than the first terminal.

### CROSS-REFERENCE TO RELATED APPLICATIONS

This application is based upon and claims the benefit of priority from Japanese Patent Application No. 2012-262298, filed Nov. 30, 2012, the entire contents of which are incorporated herein by reference.

### FIELD

Embodiments described herein relate generally to a technique for processing handwritten data.

### BACKGROUND

In recent years, various kinds of electronic apparatuses, such as a tablet, a PDA and a smartphone, have been developed. Most of these electronic apparatuses include touch-screen displays for facilitating input operations by users.

By touching a menu or an object, which is displayed on the touch-screen display, by a finger or the like, the user can instruct an electronic apparatus to execute a function which is associated with the menu or object.

However, most of existing electronic apparatuses with touch-screen displays are consumer products which are designed to enhance operability on various media data such as video and music, and are not necessarily suitable for use in a business situation such as a meeting, a business negotiation or product development. Thus, in business situations, paper-based pocket notebooks have still been widely used.

In business situations, there are cases that electronic apparatuses are expected to function as digital tools which are useful for cooperative works such as meetings. Thus, it is necessary to realize a new technique which enables easy sharing of handwritten information.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic apparatus according to an embodiment.

FIG. 2 is an exemplary view illustrating a flow of data between a system according to the embodiment and each of terminals.

FIG. 3 is a view illustrating an example of a display screen of the electronic apparatus of FIG. 1.

FIG. 4 is a view illustrating an example of a handwritten document which is handwritten on a touch-screen display of the electronic apparatus of FIG. 1.

FIG. 5 is an exemplary view for explaining time-series information (handwritten page data) corresponding to the handwritten document of FIG. 4, the time-series information being stored in a storage medium by the electronic apparatus of FIG. 1.

FIG. 6 is an exemplary block diagram illustrating a system configuration of the electronic apparatus of FIG. 1.

FIG. 7 is an exemplary block diagram illustrating a functional configuration of a handwriting note application program which is executed by the electronic apparatus of FIG. 1.

FIG. 8 is an exemplary view illustrating a stroke information management table which is stored in a database of a server system of FIG. 2.

FIG. 9 is an exemplary view illustrating an operation of delivering stroke data, which is received from a transmission-side terminal, to a reception-side terminal, the operation being executed by the system of FIG. 2.

FIG. 10 is an exemplary view illustrating an operation of delivering stroke data, which are received from two transmission-side terminals, to a reception-side terminal, the operation being executed by the system of FIG. 2.

FIG. 11 is an exemplary view illustrating an operation of exchanging stroke data between a plurality of terminals, the operation being executed by the system of FIG. 2.

FIG. 12 is an exemplary block diagram illustrating a configuration of the system of FIG. 2.

FIG. 13 is an exemplary flowchart illustrating the procedure of a stroke delivery process which is executed by the system of FIG. 2.

FIG. 14 is an exemplary flowchart illustrating the procedure of a handwritten information sharing process which is executed by the electronic apparatus of FIG. 1.

### DETAILED DESCRIPTION

Various embodiments will be described hereinafter with reference to the accompanying drawings.

In general, according to one embodiment, a system includes a receiver, a controller, and a transmitter. The receiver is configured to receive a plurality of stroke data, which correspond to a plurality of strokes handwritten on first contents in a plurality of terminals, from the plurality of terminals. The controller is configured to store the plurality of stroke data in a storage medium, the plurality of stroke data associated with an identifier of a terminal which is a sender. The transmitter is configured to transmit to a first terminal of the plurality of terminals one or more first stroke data of the plurality of stroke data. The one or more first stroke data are stroke data associated with an identifier of a terminal other than the first terminal.

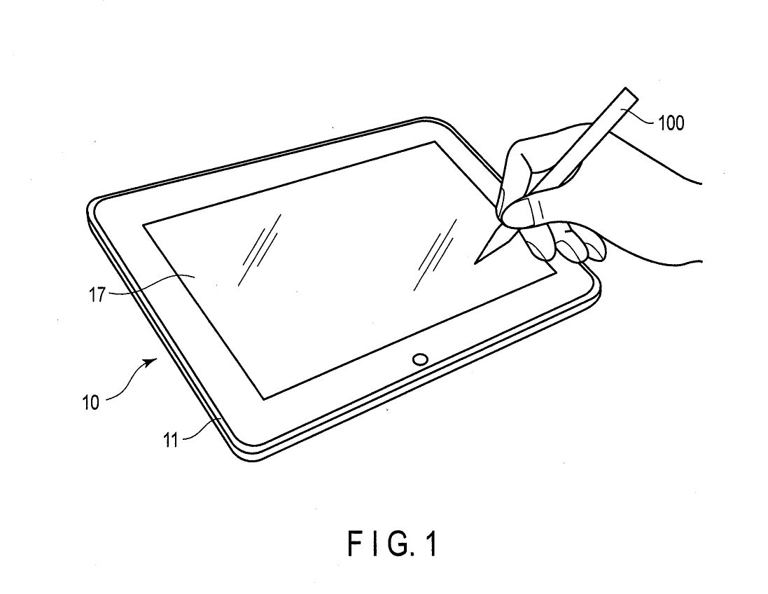

FIG. 1 is a perspective view illustrating an external appearance of an electronic apparatus according to an embodiment. The electronic apparatus is, for instance, a pen-based portable electronic apparatus which can execute a handwriting input by a pen or a finger. This electronic apparatus may be realized as a tablet computer, a notebook-type personal computer, a smartphone, a PDA, etc. In the description below, the case is assumed that this electronic apparatus is realized as a tablet computer 10. The tablet computer 10 is a portable electronic apparatus which is also called “tablet” or “slate computer”. As shown in FIG. 1, the tablet computer 10 includes a main body 11 and a touch-screen display 17. The touch-screen display 17 is attached such that the touch-screen display 17 is laid over the top surface of the main body 11.

The main body 11 has a thin box-shaped housing. In the touch-screen display 17, a flat-panel display and a sensor, which is configured to detect a touch position of a pen or a finger on the screen of the flat-panel display, are assembled. The flat-panel display may be, for instance, a liquid crystal display (LCD). As the sensor, for example, use may be made of an electrostatic capacitance-type touch panel, or an electromagnetic induction-type digitizer. In the description below, the case is assumed that two kinds of sensors, namely a digitizer and a touch panel, are both assembled in the touch-screen display 17.

Each of the digitizer and the touch panel is provided in a manner to cover the screen of the flat-panel display. The touch-screen display 17 can detect not only a touch operation on the screen with use of a finger, but also a touch operation on the screen with use of a pen 100. The pen 100 may be, for instance, an electromagnetic-induction pen. The user can execute a handwriting operation on the touch-screen display 17 by using an external object (pen 100 or finger). During the handwriting input operation, a locus of movement of the external object (pen 100 or finger) on the screen, that is, a locus (writing trace) of a stroke that is handwritten by the handwriting input operation, is drawn in real time, and thereby the locus of each stroke is displayed on the screen. A locus of movement of the external object during a time in which the external object is in contact with the screen corresponds to one stroke. A set of many strokes, which correspond to handwritten characters or graphics, that is, a set of many loci (writing traces), constitutes a handwritten document.

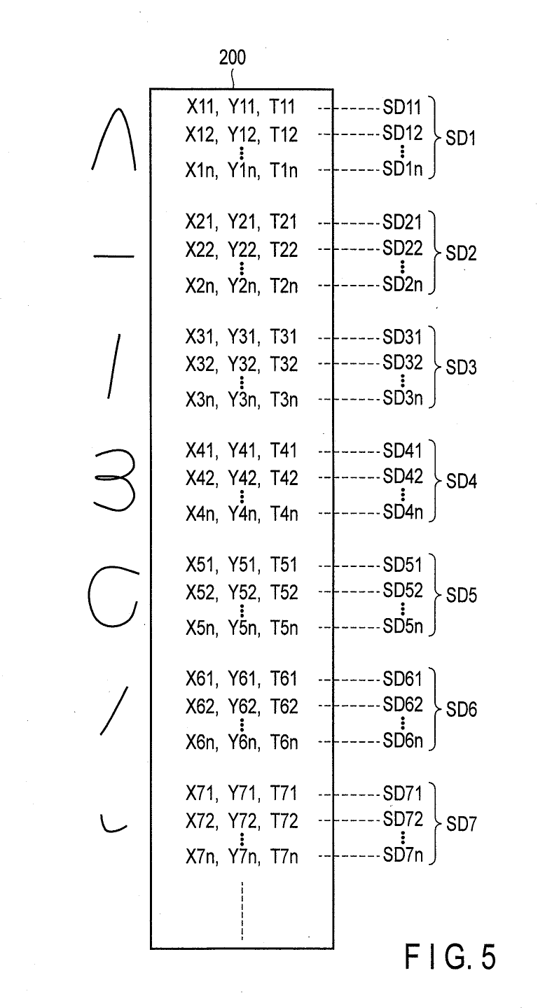

In the present embodiment, the handwritten document is stored in a storage medium not as image data but as time-series information indicative of coordinate series of each stroke and an order relation between strokes. The details of the time-series information will be described later with reference to FIG. 5. The time-series information is indicative of an order in which a plurality of strokes were handwritten, and includes a plurality of stroke data corresponding to a plurality of strokes. In other words, the time-series information means a set of time-series stroke data corresponding to a plurality of strokes, respectively. Each stroke data corresponds to a certain single stroke, and includes coordinate data series (time-series coordinates) corresponding to points on the locus of this stroke. The order of arrangement of these stroke data corresponds to an order in which strokes were handwritten, that is, an order of strokes.

The tablet computer 10 can read out arbitrary existing time-series information from the storage medium, and can display, on the screen, a handwritten document corresponding to this time-series information, that is, the loci corresponding to a plurality of strokes indicated by this time-series information. Furthermore, the tablet computer 10 has an edit function. The edit function can delete or move an arbitrary stroke or an arbitrary handwritten character or the like in the displayed handwritten document, in accordance with an edit operation by the user with use of an “eraser” tool, a range designation tool, and other various tools. As the “eraser”, use may be made of stroke data (erase stroke data) corresponding to a stroke which is handwritten in an erase mode. A stroke corresponding to the erase stroke data is an erase stoke having such an attribute as to erase (transparentize) some other stroke. An intersection part between an erase stroke and some other normal stroke is transparentized. In other words, the intersection part of this other stroke is erased (transparentized). A user can visually recognize, through the transparent intersection part, a background layer, or an under-layer on which other content is displayed.

In addition, this edit function includes a function of clearing the history of some handwriting operations. Besides, this edit function can add an arbitrary handwritten character or handwritten symbol to a handwritten document which is being displayed.

In this embodiment, the time-series information may be managed as one page or plural pages. In this case, the time-series information may be divided in units of an area which falls within one screen, and thereby a piece of time-series information, which falls within one screen, may be stored as one page. Alternatively, the size of one page may be made variable. In this case, since the size of a page can be increased to an area which is larger than the size of one screen, a handwritten document of an area larger than the size of the screen can be handled as one page. When one whole page cannot be displayed on the display at a time, this page may be reduced in size and displayed, or a display target part in the page may be moved by vertical and horizontal scroll.

In this manner, since the time-series information can be managed as page data, the time-series information will be also referred to as “handwritten page data” or simply as “handwritten data” in the description below.

The tablet computer 10 includes a network communication function, and can cooperate with other personal computers or servers on the Internet. Specifically, the tablet computer 10 includes a wireless communication device of, e.g. a wireless LAN, and can execute wireless communication with other personal computers. In addition, the tablet computer 10 can communicate with various servers on the Internet.

The server includes a large-capacity storage medium such as a hard disk drive (HDD). The tablet computer 10 transmits time-series information (handwritten page data) to the server over the network, and can store the time-series information (handwritten page data) in the storage medium in the server (“upload”). In order to ensure a secure communication between the tablet computer 10 and the server, the server may authenticate the tablet computer 10 at a time of starting the communication. In this case, a dialog for prompting the user to input an ID or a password may be displayed on the screen of the tablet computer 10, or the ID of the tablet computer 10, for example, may be automatically transmitted from the tablet computer 10 to the server.

Thereby, even when the capacity of the storage in the tablet computer 10 is small, the tablet computer 10 can handle many time-series information items (handwritten page data) or large-volume time-series information (handwritten page data).

In addition, the tablet computer 10 can read out (“download”) one or more arbitrary time-series information items (handwritten page data) stored in the storage medium of the server, and can display the locus of each stroke indicated by the read-out time-series information on the screen of the display 17 of the tablet computer 10. In this case, the tablet computer 10 may display on the screen of the display 17 a list of thumbnails (thumbnail images) which are obtained by reducing in size pages of plural time-series information items (handwritten page data), or may display one page, which is selected from these thumbnails, on the screen of the display 17 in the normal size.

As has been described above, in the present embodiment, the storage medium in which the time-series information is stored may be the storage in the tablet computer 10, or the storage in the server. The user of the tablet computer 10 can store arbitrary time-series information in an arbitrary one selected from between the storage in the tablet computer 10 and the storage in the server.

Furthermore, in the tablet computer 10, an object, such as a character or graphic, can be handwritten on a Web page, text, an image or other various contents. In this case, a handwritten stroke is drawn on a transparent layer which is set on displayed content. Thereby, the locus of this stroke can be displayed over the above-described content. In addition, the tablet computer 10 can share the stroke data, which corresponds to each stroke handwritten over the content, with other terminals.

For example, in a meeting, participants of the meeting cause their tablet computers to display the same content (the same material of the meeting), that is, contents corresponding to the same content. In the meeting, there is a case in which the chairman or each speaker handwrites a character, a graphic, etc. on the content displayed on the screen of the tablet computer. A plurality of stroke data which are correspond to the handwritten characters or graphics are delivered to the tablet computers of the other participants in the meeting via a server system. Then, the stroke corresponding to the character or graphic handwritten by the chairman or each speaker is drawn on the content on the screen of each tablet computer. Thereby, handwritten information (handwritten characters, handwritten graphics, etc.) can be exchanged/shared between the participants in the meeting.

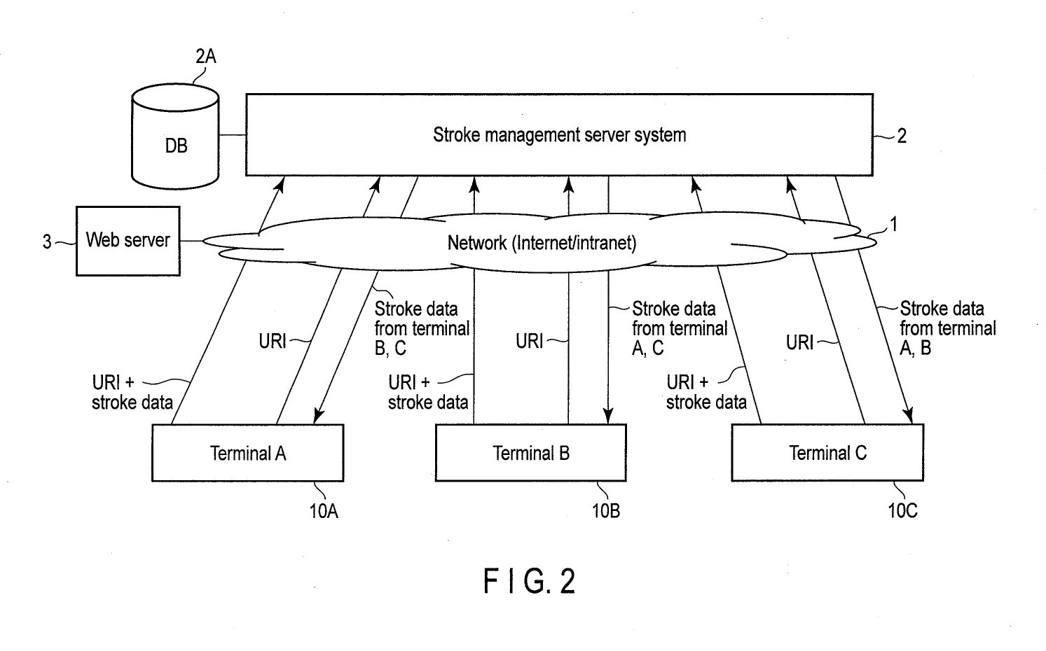

FIG. 2 illustrates a stroke management server system 2 configured to execute a process for sharing handwritten information between a plurality of terminals. The stroke management server system 2 is a system for sharing a stroke handwritten on the same content between a plurality of terminals. The stroke management server system 2 is realized by one or more servers. The stroke management server system 2 communicates with a plurality of terminals (terminals 10A, 10B and 10C in this example) via a network 1 such as the Internet or an intranet. The terminal 10A is a tablet computer which is used by a user A, the terminal 10B is a tablet computer which is used by a user B, and the terminal 10C is a tablet computer which is used by a user C.

Each of the terminals 10A, 10B and 10C is a terminal having the same handwriting function as the tablet computer 10 of the present embodiment. Each of the terminals 10A, 10B and 10C has the capability of communicating with each of the stroke management server system 2 and a Web server 3 via the Internet. The case is now assumed that the same content, which is shared between the terminals 10A, 10B and 10C, is a specific Web page which is received from the Web server 3. Each of the terminals 10A, 10B and 10C acquires the specific Web page from the Web server 3 and displays the specific Web page on the display screen of each terminal.

If the user A executes a handwriting input operation on the Web page on the display screen of the terminal 10A, a first stroke written by the handwriting input operation is displayed on the Web page.

The terminal 10A transmits to the stroke management server system 2 first stroke data corresponding to the first stroke handwritten by the user A on the Web page (content) that is displayed on the display of the terminal 10A. The terminal 10A can receive from the stroke management server system 2 second stroke data corresponding to a second stroke which is handwritten by the user B on the above-described Web page (content) that is displayed on the display of another terminal 10B. Based on the second stroke data, the terminal 10A can display the second stroke on the Web page (content) that is displayed on the display of the terminal 10A.

Further, the terminal 10A can also receive from the stroke management server system 2 third stroke data corresponding to a third stroke which is handwritten by the user C on the above-described Web page (content) that is displayed on the display of the other terminal 10C. Based on the third stroke data, the terminal 10A can display the third stroke on the Web page (content) displayed on the display of the terminal 10A.

Accordingly, on the display of the terminal 10A, not only the handwritten object of the user A is displayed on the Web page, but also the handwritten object of the user B, as well as the handwritten object of the user C, is displayed on the Web page.

Similarly, on the display of the terminal 10B, not only the handwritten object of the user B is displayed on the Web page, but also the handwritten object of the user A, as well as the handwritten object of the user C, is displayed on the Web page. In like manner, on the display of the terminal 10C, not only the handwritten object of the user C is displayed on the Web page, but also the handwritten object of the user A, as well as the handwritten object of the user B, is displayed on the Web page.

The stroke management server system 2 receives stroke data from each of a plurality of terminals browsing the same Web page (same content). Specifically, the stroke management server system 2 receives from the terminals 10A, 10B and 10C a plurality of stroke data corresponding to a plurality of strokes which are handwritten on the above-described Web page in the respective terminals 10A, 10B and 10C. Then, the stroke management server system 2 stores in a database 2A each of the plural stroke data in the state in which said each of the plurality of stroke data is associated with an identifier of a terminal which is a sender of said each of the plurality of stroke data. For example, each stroke data, which is received from the terminal 10A, is associated with the identifier of the terminal 10A (or the identifier of the user A) and is stored in the database 2A. Similarly, each stroke data, which is received from the terminal 10B, is associated with the identifier of the terminal 10B (or the identifier of the user B) and is stored in the database 2A, and each stroke data, which is received from the terminal 10C, is associated with the identifier of the terminal 10C (or the identifier of the user C) and is stored in the database 2A. The identifier may be any information which can identify the terminal. For example, the identifier may be existing information such as a MAC address or an IP address, or may be information which is set by the system to which the terminals 10A, 10B and 10C belong, or may be information which is given to the terminals 10A, 10B and 10C by the stroke management server system 2, or may be information which is set for each terminal, based on a random number.

Then, the stroke management server system 2 transmits to a certain first terminal of the terminals 10A, 10B and 10C one or more first stroke data of the above-described plural stoke data. The one or more first stroke data are one or more stroke data which are associated with the identifiers of the terminals other than the first terminal. When transmitting to the terminal 10A stroke data of each of the other terminals (terminals 10B and 10C), the stroke management server system 2 selects, from the above-described plural stroke data, stroke data which is associated with the identifier of the terminal 10B and stroke data which is associated with the identifier of the terminal 10C. Then, the stroke management server system 2 transmits these selected stroke data to the terminal 10A as the above-described first stroke data (strokes handwritten in the other terminals).

Further, the stroke management server system 2 can store in the database 2A each of the above-described stroke data in the state in which each stroke data is associated with time information corresponding to the handwriting timing of this stroke data. In this case, the stroke management server system 2 transmits to each terminal a set of stroke data and the time information corresponding to this stroke data. For example, when stroke data of the other terminals (terminals 10B and 10C) is to be provided to the terminal 10A, the stroke management server system 2 selects stroke data, which is associated with the identifier of the terminal 10B, from among the above-described plural stroke data, and transmits to the terminal 10A the selected stroke data and the time information corresponding to this selected stroke data. Further, the stroke management server system 2 selects stroke data, which is associated with the identifier of the terminal 10C, from among the above-described plural stroke data, and transmits to the terminal 10A the selected stroke data and the time information corresponding to this selected stroke data.

In this manner, not only each stroke data but also the time information corresponding to each stroke data is transmitted to the terminal 10A. Thereby, in the terminal 10A, the order relation between strokes (the order of strokes, the timing of handwriting of strokes) can be reproduced. Furthermore, it is possible to reproduce the order relation between strokes such as handwritten characters written in the terminal 10B and strokes such as handwritten characters written in the terminal 10C.

A description is given of an example of the procedure of communication between each terminal and the stroke management server system 2.

Each time one stroke is handwritten on the display of the terminal 10A on which the above-described Web page is displayed, the terminal 10A transmits to the stroke management server system 2 a set of one stroke data corresponding to this one handwritten stroke and the identifier (URI) of the Web page. The stroke data may include time information (time stamp) indicative of a time at which the corresponding stroke was handwritten. The time information may be an absolute time (e.g. GMT) or a relative time. The relative time is information indicative of a difference between a timing at which an immediately preceding stroke was handwritten and a timing at which a stroke that is a present transmission target was handwritten. Further, the stroke data may include pen type information (e.g. the thickness of a stroke, the color of a stroke) of the corresponding stroke. Besides, the pen type information may include information for identifying a stroke which is handwritten in the erase mode.

In addition, in order to precisely specify the above-described Web page, update date/time information of the above-described Web page, as well as the identifier (URI) of the Web page, may be transmitted from the terminal 10A to the stroke management server system 2.

In like manner, each time one stroke is handwritten on the display of the terminal 10B on which the above-described Web page is displayed, the terminal 10B transmits to the stroke management server system 2 a set of one stroke data corresponding to this one handwritten stroke and the identifier (URI) of the Web page. Similarly, each time one stroke is handwritten on the display of the terminal 10C on which the above-described Web page is displayed, the terminal 10C transmits to the stroke management server system 2 a set of one stroke data corresponding to this one handwritten stroke and the identifier (URI) of the Web page.

The stroke management server system 2 stores the stroke data and the URI as one set in the database 2A. Each of the terminals 10A, 10B and 10C periodically (e.g. in every one to two seconds) polls the stroke management server system 2, and acquires stroke data, which is associated with the above-described URI, from the stroke management server system 2. In the polling, each of the terminals 10A, 10B and 10C transmits the above-described URI of the Web page to the stroke management server system 2. If new stroke data, which is associated with the URI and has not yet been acquired, is present in the stroke management server system 2, each of the terminals 10A, 10B and 10C acquires the new stroke data from the stroke management server system 2. In the stroke management server system 2, each stroke data is managed by being associated with the terminal ID of the terminal that is the sender of the stroke data. Thus, the stroke data, which is associated with the terminal 10B or 10C, is provided to the terminal 10A, the stroke data, which is associated with the terminal 10A or 10C, is provided to the terminal 10B, and the stroke data, which is associated with the terminal 10A or 10B, is provided to the terminal 10C.

Each of the terminals 10A, 10B and 10C draws a stroke, which corresponds to each acquired stroke data, on the Web page. In this case, in each of the terminals 10A, 10B and 10C, stroke data for a predetermined time period may be buffered. Thereby, strokes can be drawn on the Web page in an order of timings at which the respective strokes were handwritten.

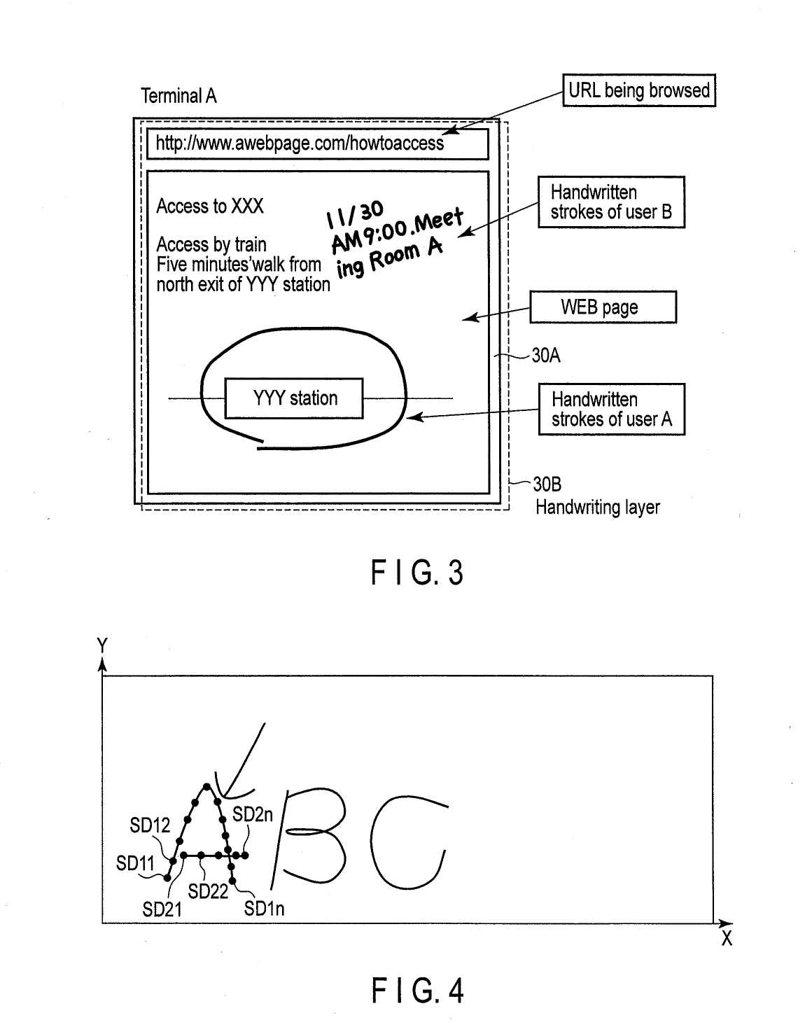

FIG. 3 illustrates an example of the display screen of the terminal 10A. The case is now assumed that the terminals 10A, 10B and 10C are browsing a Web page of URL “http://www.awebpage.com/howtoaccess”. A transparent layer (handwriting layer) 30B is set over a screen image 30A of the Web page. Each of strokes, which are handwritten by the user, is drawn on the layer 30B, and thereby each stroke (the locus of each stroke) is displayed on the screen image 30A of the Web page (“overlay”). Strokes, which are handwritten on the screen image 30A of the Web page, are successively transmitted to the stroke management server system 2 in units of one stroke.

In FIG. 3, the case is assumed that an oval stroke surrounding a rectangular object “YYY station” in the Web page has been handwritten by the user A. The stroke data corresponding to this stroke, together with meta-information such as URL “http://www.awebpage.com/howtoaccess”, is transmitted to the stroke management server system 2, and the stroke data and meta-information are stored in the database 2A. The terminal 10A periodically requests stroke data relating to URL “http://www.awebpage.com/howtoaccess” from the stroke management server system 2. If the user B of the terminal 10B has handwritten, for example, a character on the Web page of URL “http://www.awebpage.com/howtoaccess”, which is displayed on the display of the terminal 10B, stroke data corresponding to this handwritten character are stored in the database 2A of the stroke management server system 2. The terminal 10A can receive these stroke data of the terminal 10B from the stroke management server system 2. Strokes corresponding to these stroke data are drawn on the layer 30B, and thereby each stroke (the locus of each stroke) of the user B is displayed on the screen image 30A of the Web page (“overlay”).

Next, referring to FIG. 4 and FIG. 5, a description is given of a relationship between strokes (characters, marks, graphics, tables, etc.), which are handwritten by the user, and time-series information. FIG. 4 shows an example of a handwritten document (handwritten character string) which is handwritten on the touch-screen display 17 by using the pen 100 or the like.

In many cases, on a handwritten document, other characters or graphics are handwritten over already handwritten characters or graphics. In FIG. 4, the case is assumed that a handwritten character string “ABC” was handwritten in the order of “A”, “B” and “C”, and thereafter a handwritten arrow was handwritten near the handwritten character “A”.

The handwritten character “A” is expressed by two strokes (a locus of “ [symbol] ” shape, a locus of “-” shape) which are handwritten by using the pen 100 or the like, that is, by two loci. The locus of the pen 100 of the first handwritten “ [symbol] ” shape is sampled in real time, for example, at regular time intervals, and thereby time-series coordinates SD11, SD12, . . . , SD1n of the stroke of the “ [symbol] ” shape are obtained. Similarly, the locus of the pen 100 of the next handwritten “-” shape is sampled in real time, for example, at regular time intervals, and thereby time-series coordinates SD21, SD22, . . . , SD2n of the stroke of the “-” shape are obtained.

The handwritten character “B” is expressed by two strokes which are handwritten by using the pen 100 or the like, that is, by two loci. The handwritten character “C” is expressed by one stroke which is handwritten by using the pen 100 or the like, that is, by one locus. The handwritten “arrow” is expressed by two strokes which are handwritten by using the pen 100 or the like, that is, by two loci.

FIG. 5 illustrates time-series information (handwritten page data) 200 corresponding to the handwritten document of FIG. 4. The time-series information 200 includes a plurality of stroke data SD1, SD2, . . . , SD7. In the time-series information 200, the stroke data SD1, SD2, . . . , SD7 are arranged in time series in the order of strokes, that is, in the order in which plural strokes were handwritten.

In the time-series information 200, the first two stroke data SD1 and SD2 are indicative of two strokes of the handwritten character “A”. The third and fourth stroke data SD3 and SD4 are indicative of two strokes which constitute the handwritten character “B”. The fifth stroke data SD5 is indicative of one stroke which constitutes the handwritten character “C”. The sixth and seventh stroke data SD6 and SD7 are indicative of two strokes which constitute the handwritten “arrow”.

Each stroke data includes coordinate data series (time-series coordinates) corresponding to one stroke, that is, a plurality of coordinates corresponding to a plurality of points on the locus of one stroke. In each stroke data, the plural coordinates are arranged in time series in the order in which the stroke is written. For example, as regards handwritten character “A”, the stroke data SD1 includes coordinate data series (time-series coordinates) corresponding to the points on the locus of the stroke of the handwritten “ [symbol] ” shape of the handwritten character “A”, that is, an n-number of coordinate data SD11, SD12, . . . , SD1n. The stroke data SD2 includes coordinate data series corresponding to the points on the locus of the stroke of the handwritten “-” shape of the handwritten character “A”, that is, an n-number of coordinate data SD21, SD22, . . . , SD2n. Incidentally, the number of coordinate data may differ between respective stroke data.

Each coordinate data is indicative of an X coordinate and a Y coordinate, which correspond to one point in the associated locus. For example, the coordinate data SD11 is indicative of an X coordinate (X11) and a Y coordinate (Y11) of the starting point of the stroke of the “ [symbol] ” shape. The coordinate data SD1n is indicative of an X coordinate (X1n) and a Y coordinate (Y1n) of the end point of the stroke of the “ [symbol] ” shape.

Further, each coordinate data may include time stamp information T corresponding to a time point at which a point corresponding to the coordinates of this coordinate data was handwritten. The time point at which the point was handwritten may be either an absolute time (e.g. year/month/day/hour/minute/second) or a relative time with reference to a certain time point. For example, an absolute time (e.g. year/month/day/hour/minute/second) at which a stroke began to be handwritten may be added as time stamp information to each stroke data, and furthermore a relative time indicative of a difference from the absolute time may be added as time stamp information T to each coordinate data in the stroke data.

In this manner, by using the time-series information in which the time stamp information T is added to each coordinate data, the temporal relation between strokes can be more precisely expressed.

Moreover, information (Z) indicative of a pen stroke pressure may be added to each coordinate data.

The time-series information 200 having the structure as described with reference to FIG. 5 can express not only the trace of handwriting of each stroke, but also the temporal relation between strokes. Thus, with the use of the time-series information 200, even if a distal end portion of the handwritten “arrow” is written over the handwritten character “A” or near the handwritten character “A”, as shown in FIG. 4, the handwritten character “A” and the distal end portion of the handwritten “arrow” can be treated as different characters or graphics.

In the meantime, as the time stamp information of the stroke data SD1, use may be made of an arbitrary one selected from among a plurality of time stamp information items T11 to T1n corresponding to a plurality of coordinates in the stroke data SD1, or a mean value of the time stamp information items T11 to T1n. Similarly, as the time stamp information of the stroke data SD2, use may be made of an arbitrary one selected from among a plurality of time stamp information items T21 to T2n corresponding to a plurality of coordinates in the stroke data SD2, or a mean value of the time stamp information items T21 to T2n. In like manner, as the time stamp information of the stroke data SD7, use may be made of an arbitrary one selected from among a plurality of time stamp information items. T71 to T7n corresponding to a plurality of coordinates in the stroke data SD7, or a mean value of the time stamp information items T71 to T7n.

In the time-series information 200 of the present embodiment, as described above, the arrangement of stroke data SD1, SD2, . . . , SD7 indicates the order of strokes of handwritten characters. For example, the arrangement of stroke data SD1 and SD2 indicates that the stroke of the “ [symbol] ” shape was first handwritten and then the stroke of the “-” shape was handwritten. Thus, even when the traces of writing of two handwritten characters are similar to each other, if the orders of strokes of the two handwritten characters are different from each other, these two handwritten characters can be distinguished as different characters.

Furthermore, in the present embodiment, as described above, a handwritten document is stored not as an image or a result of character recognition, but as the time-series information 200 which is composed of a set of time-series stroke data corresponding to a plurality of strokes. Thus, handwritten characters can be handled, without depending on languages of the handwritten characters. Therefore, the structure of the time-series information 200 of the present embodiment can be commonly used in various countries of the world where different languages are used.

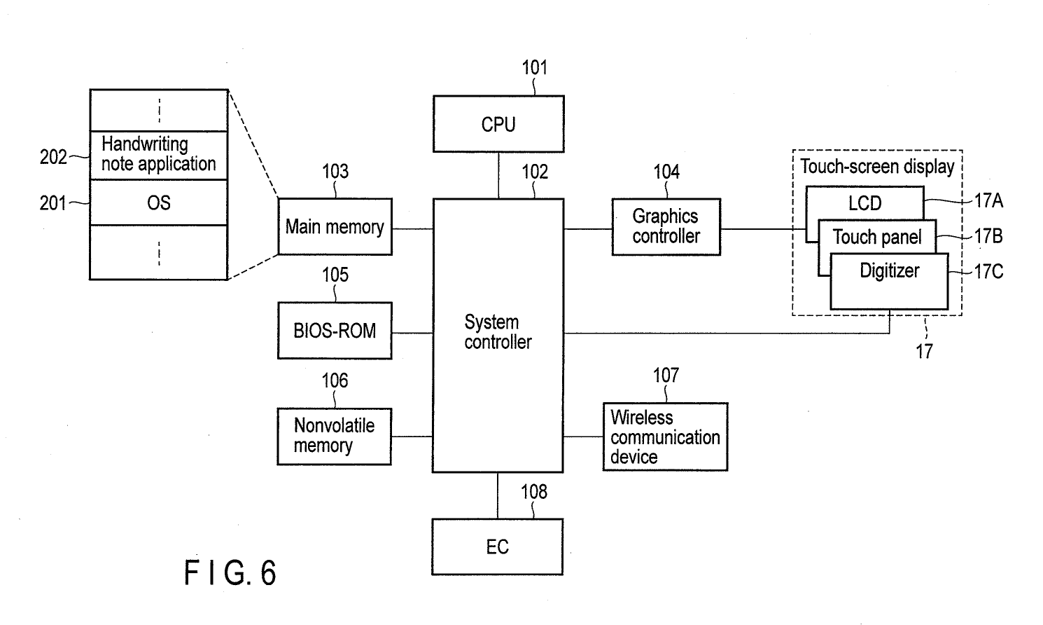

FIG. 6 illustrates a system configuration of the tablet computer 10.

As shown in FIG. 6, the tablet computer 10 includes a CPU 101, a system controller 102, a main memory 103, a graphics controller 105, a BIOS-ROM 105, a nonvolatile memory 106, a wireless communication device 107, and an embedded controller (EC) 108.

The CPU 101 is a processor which controls the operations of various modules in the tablet computer 10. The CPU 101 executes various kinds of software, which are loaded from the nonvolatile memory 106 that is a storage device into the main memory 103. The software includes an operating system (OS) 201 and various application programs. The application programs include a handwriting note application 202. The handwriting note application 202 includes a browser function for browsing content such as a Web page, a function of drawing a handwritten stroke on the content, and a function of cooperating with the stroke management server system 2.

In addition, the CPU 101 executes a basic input/output system (BIOS) which is stored in the BIOS-ROM 105. The BIOS is a program for hardware control.

The system controller 102 is a device which connects a local bus of the CPU 101 and various components. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the tablet computer 10. A display signal, which is generated by the graphics controller 104, is sent to the LCD 17A. The LCD 17A displays a screen image based on the display signal. A touch panel 17B and a digitizer 17C are disposed on the LCD 17A. The touch panel 17B is an electrostatic capacitance-type pointing device for executing an input on the screen of the LCD 17A. A contact position on the screen, which is touched by a finger, and a movement of the contact position, are detected by the touch panel 17B. The digitizer 17C is an electromagnetic induction-type pointing device for executing an input on the screen of the LCD 17A. A contact position on the screen, which is touched by the pen 100, and a movement of the contact position, are detected by the digitizer 17C.

The wireless communication device 107 is a device configured to execute wireless communication such as wireless LAN or 3G mobile communication. The EC 108 is a one-chip microcomputer including an embedded controller for power management. The EC 108 includes a function of powering on or powering off the tablet computer 10 in accordance with an operation of a power button by the user.

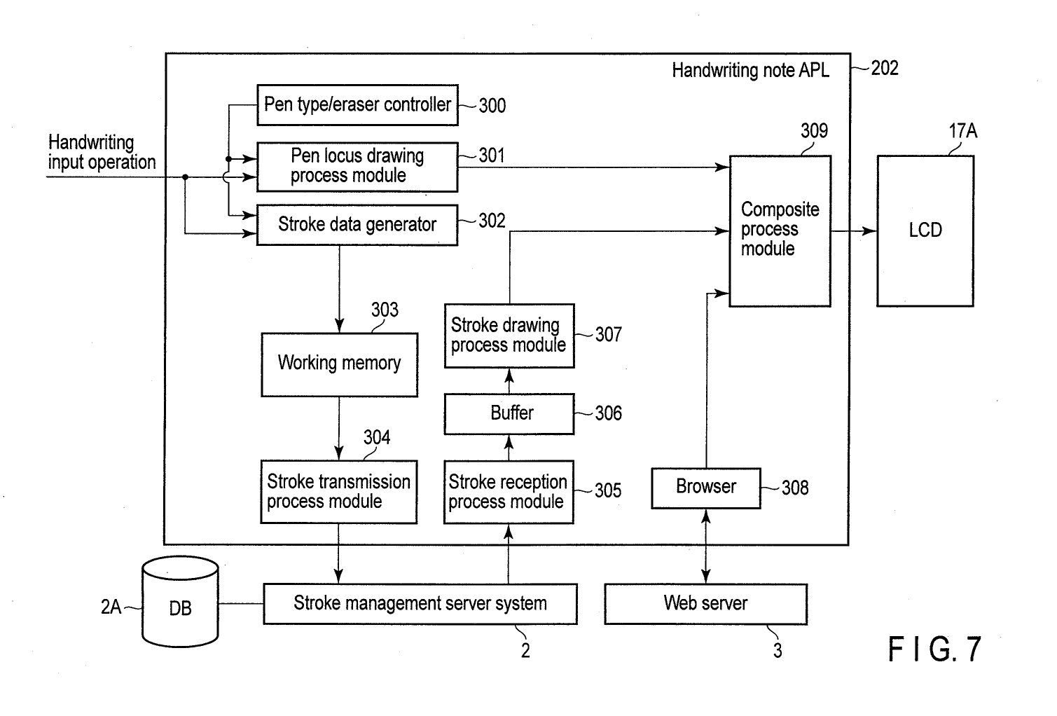

Next, referring to FIG. 7, a functional configuration of the handwriting note application program 202 is described.

The handwriting note application 202 includes a pen type/eraser controller 300, a pen locus drawing process module 301, a stroke data generator 302, a stroke transmission process module 304, a stroke reception process module 305, a stroke drawing process module 307, a browser 308 and a composite process module 309.

The handwriting note application program 202 executes creation, display and edit of handwritten page data, by using stroke data which is input with use of the touch-screen display 17. The touch-screen display 17 is configured to detect the occurrence of events such as “touch”, “move (slide)” and “release”. The “touch” is an event indicating that an external object has come in contact with the screen. The “move (slide)” is an event indicating that the position of contact of the external object has been moved while the external object is in contact with the screen. The “release” is an event indicating that the external object has been released from the screen.

The pen type/eraser controller 300 displays a graphical user interface, such as a menu or a button, on the touch-screen display 17. The pen type/eraser controller 300 receives a “touch” event which is generated by the touch-screen display 17, thereby detecting an operation of the graphical user interface by the user. The “touch” event includes coordinates of a touch position. Thus, the pen type/eraser controller 300 can detect that the button or menu on the graphical user interface has been touched. The handwriting note application program 202 has an input mode for handwriting a character or graphic, and an erase mode for handwriting the above-described erase stroke. A stroke handwritten in the erase mode is treated as the above-described erase stroke. In addition, the user can designate the thickness or color of a stroke (the locus corresponding to a stroke) which is drawn.

The pen locus drawing process module 301 and stroke data generator 302 receive a “touch” event or a “move (slide)” event which is generated by the touch-screen display 17, thereby detecting a handwriting input operation. As described above, the “touch” event includes coordinates of a touch position. The “move (slide)” event also includes coordinates of a touch position at a destination of movement. Thus, the pen locus drawing process module 301 and stroke data generator 302 can receive coordinate series corresponding to the locus of movement of the contact position.

The pen locus drawing process module 301 receives coordinate series from the touch-screen display 17 and displays, based on the coordinate series, the locus of each stroke, which is handwritten by a handwriting input operation with use of the pen 100 or the like, on the above-described layer 30B, with the thickness and color designated by the pen type/eraser controller 300. By this pen locus drawing process module 301, the locus of the pen 100 during the time in which the pen 100 is in contact with the screen, that is, the locus of each stroke, is drawn on the layer 30B.

The stroke data generator 302 receives the above-described coordinate series which is output from the touch-screen display 17 and generates, based on the coordinate series, stroke data having the structure described in detail with reference to FIG. 5. In this case, the stroke data, namely the coordinates corresponding to the respective points of the stroke and the time stamp information, may be temporarily stored in a working memory 303.

Each time one stroke is handwritten on the Web page displayed by the browser, the stroke transmission process module 304 functions as a transmitter configured to transmit to the stroke management server system 2 the URI (URL) of the Web page and the stroke data corresponding to the one stroke handwritten on the Web page.

The stroke reception process module 305 functions as a receiver configured to periodically (e.g. in every one to two seconds) poll the stroke management server system 2, and to receive stroke data, which is associated with the Web page that is currently displayed by the browser, from the stroke management server system 2. In this case, since the set of the stroke data, the above-described time information and pen type information is transmitted from the stroke management server system 2, the stroke reception process module 305 receives the set of the stroke data, time information and pen type information. The received set of the stroke data, time information and pen type information may temporarily be stored in the buffer 306.

The stroke drawing process module 307 draws a stroke (the locus of a stroke) corresponding to the received stroke data on the layer 30B with the thickness and color designated by the pen type information. The stroke drawing process module 307 includes the function of handling the above-described erase stroke data. If the received stroke data is the erase stroke data, the stroke drawing process module 307 draws on the layer 30B a stroke (erase stroke) for transparentizing some other stroke. A part of each existing stroke, which is located under the locus of this erase stroke, is made transparent.

The composite process module 309 composites a screen image of Web content, which is drawn by the browser 308, and the layer 30B. Thereby, the composite process module 309 displays each stroke on the screen image of the Web content.

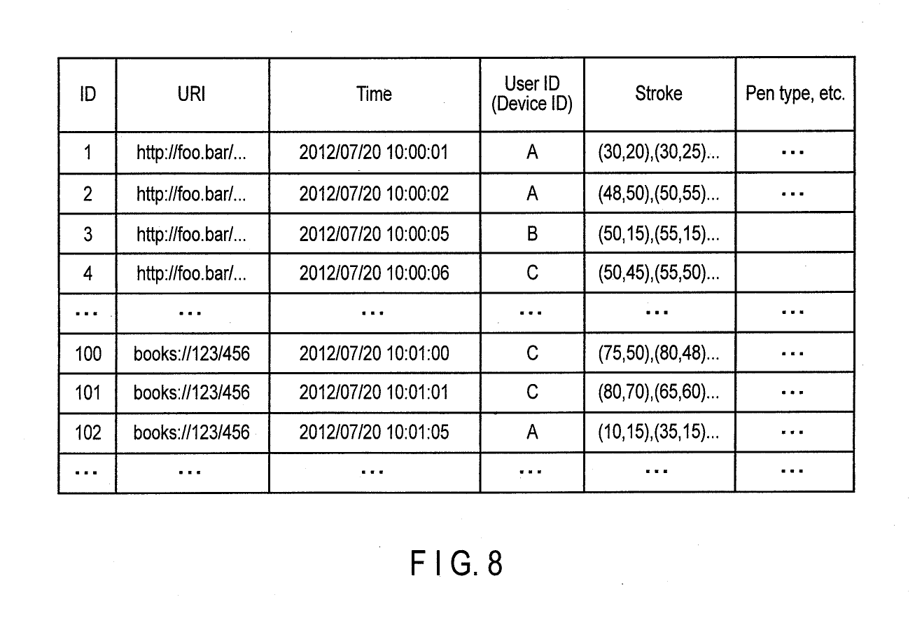

FIG. 8 illustrates a stroke information management table which is stored in the database 2A of the stroke management server system 2. The stroke information management table includes many records. One stroke (one stroke of handwriting) is allocated to one record in the stroke information management table. Each record stores a URI which identifies content, time information (GMT or local time) indicative of a time at which a stroke was written, a user ID (device ID), a stroke (coordinate series), and pen type information. The stroke management server system 2 can convert time stamp information, which has been added to stroke data received from each terminal, to an absolute time (year/month/day/hour/minute/second), and can register this absolute time as time information in the record. Needless to say, the time stamp information, which has been added to the stroke data, may be registered as the above-described time information in the record. The user ID (device ID) is an identifier of a terminal which is a sender of stroke data.

The URI may be any information if it can identify at least one of the location and the name of a resource (including content, information resource, etc.). The URI may be, for instance, an identifier of content on the Internet, such as an http scheme, or a scheme which is independently expanded in the system, or information which can identify the same content (e.g. electronic book) which is locally possessed by each terminal.

When a file of certain content is first opened, each terminal acquires from the stroke management server system 2 (1) one or more stroke data which correspond to the URI of the opened content and each have a time belonging in a time period from a time point, which is a predetermined time before the present time point, to the present time point, or (2) one or more stroke data which correspond to the URI of the opened content and the number of which is a reference number of data or less, or (3) one or more stroke data each having a time after the last date of update of the opened content. Thereafter, each terminal accesses the stroke management server system 2 at regular time intervals, and acquires from the stroke management server system 2 one or more stroke data each having a time belonging in a time period from a previous acquisition time to the present acquisition time.

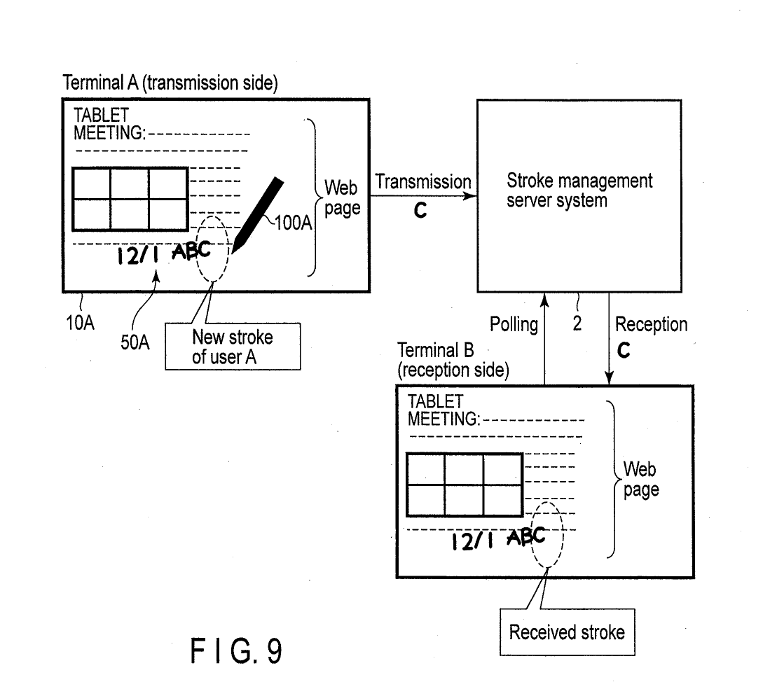

FIG. 9 illustrates a state in which a stroke, which has been handwritten on content displayed on the screen of the terminal 10A, is displayed on the screen of the terminal 10B.

If one stroke has been written on the content displayed on the screen of the terminal 10A, the stroke data corresponding to this stroke is transmitted to the stroke management server system 2. In FIG. 9, the case is assumed that the terminal 10A and terminal 10B are browsing the same Web page and a character string 50A has been handwritten by the user A on the Web page displayed on the screen of the terminal 10A. The terminal 10B polls the stroke management server system 2 at regular time intervals. If one or more new stroke data are present on the stroke management server system 2, the terminal 10B receives the one or more new stroke data. In the terminal 10B, each received stroke data is buffered, and after a wait of a predetermined time, drawing of a stroke is started. If priority is placed on a real-time operation, this wait time may be set to zero or a very short time. Alternatively, if priority is placed on reproducibility of writing, this wait time may be set to a relative long time.

FIG. 9 illustrates an example in which a stroke written on the screen of the terminal 10A is displayed on the screen of the terminal 10B substantially in real time.

Although the case in which the terminal 10A is the transmission side and the terminal 10B is the reception side has been illustrated by way of example, the communication between the terminals may be executed by a full duplex system.

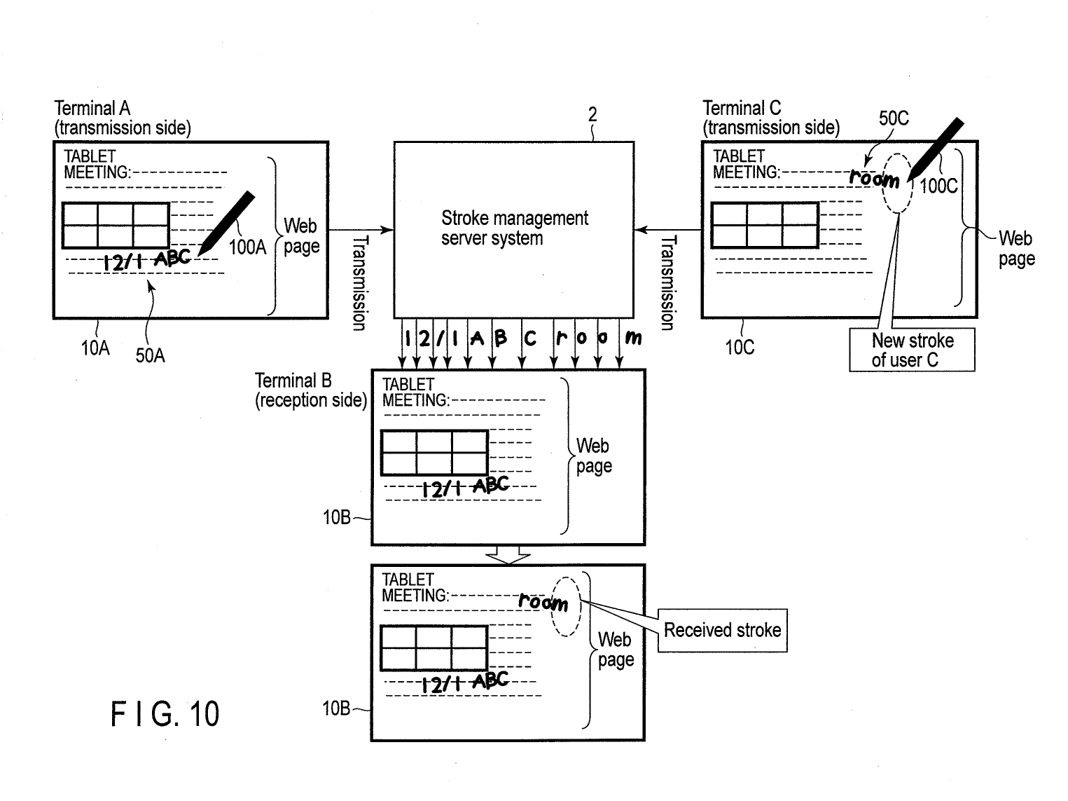

FIG. 10 illustrates a state in which a stroke, which has been handwritten on content displayed on the screen of the terminal 10A, and a stroke, which has been handwritten on content displayed on the screen of the terminal 10C, are displayed on the screen of the terminal 10B.

If one stroke has been written on the content displayed on the screen of the terminal 10A, the stroke data corresponding to this stroke is transmitted to the stroke management server system 2. In FIG. 10, the case is assumed that the three terminals 10A, 10B and 10C are browsing the same Web page, and that a character string 50A has been handwritten by the user A on the Web page displayed on the screen of the terminal 10A and then a character string 50C has been handwritten by the user C on the Web page displayed on the screen of the terminal 10C. In this case, in the stroke information management table, the time of each of stroke data corresponding to the handwritten character string 50C is later than the time of each of stroke data corresponding to the handwritten character string 50A.

The terminal B receives each stroke data corresponding to the handwritten character string 50A and each stroke data corresponding to the handwritten character string 50C, and also receives time information together with each stroke data, as described above. Thus, in the terminal 10B, strokes corresponding to the character string 50A are first displayed on the Web page that is displayed on the screen of the terminal B, and then strokes corresponding to the character string 50C are displayed on Web page.

Although the case in which each of the terminals 10A and 10C is the transmission side and the terminal 10B is the reception side has been illustrated by way of example, the communication between the terminals may be executed by a full duplex system. Specifically, the terminal 10A may become not only the transmission side, but also the reception side which receives strokes handwritten in the terminals 10B and 10C. Similarly, the terminal 10C may become not only the transmission side, but also the reception side which receives strokes handwritten in the terminals 10A and 10B. The terminal 10B may become not only the reception side, but also the transmission side which transmits strokes handwritten in the terminal 10B.

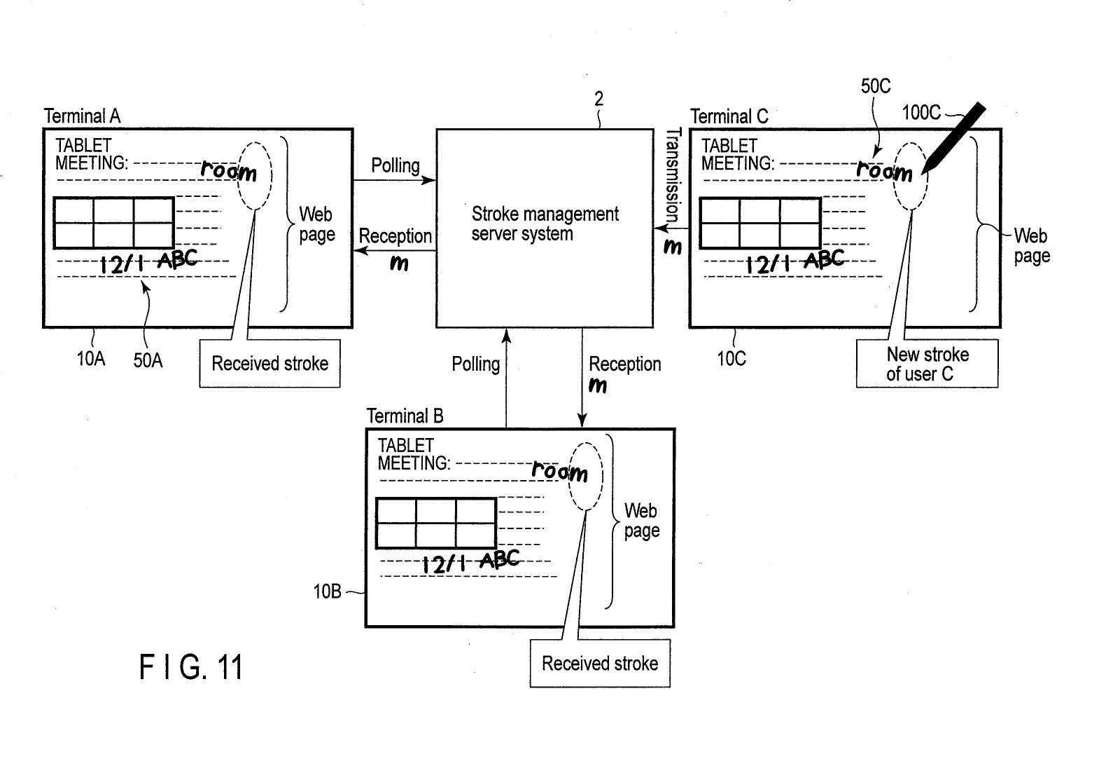

FIG. 11 illustrates a case in which the three terminals 10A, 10B and 10C communicate with each other by a full duplex system. The stroke data corresponding to each of the strokes of a character string 50A, which has been handwritten by the user A, is transmitted from the terminal 10A to the stroke management server system 2, and then the stroke data is transmitted from the stroke management server system 2 to the terminals 10B and 10C. Thus, each of the strokes of the character string 50A is displayed on the Web page that is displayed on the screen of the terminal 10B. Similarly, each of the strokes of the character string 50A is displayed on the Web page that is displayed on the screen of the terminal 10C.

The stroke data corresponding to each of the strokes of a character string 50C, which has been handwritten by the user C, is transmitted from the terminal 10C to the stroke management server system 2, and then the stroke data is transmitted from the stroke management server system 2 to the terminals 10A and 10B. Thus, each of the strokes of the character string 50C is displayed on the Web page that is displayed on the screen of the terminal 10A. Similarly, each of the strokes of the character string 50C is displayed on the Web page that is displayed on the screen of the terminal 10B.

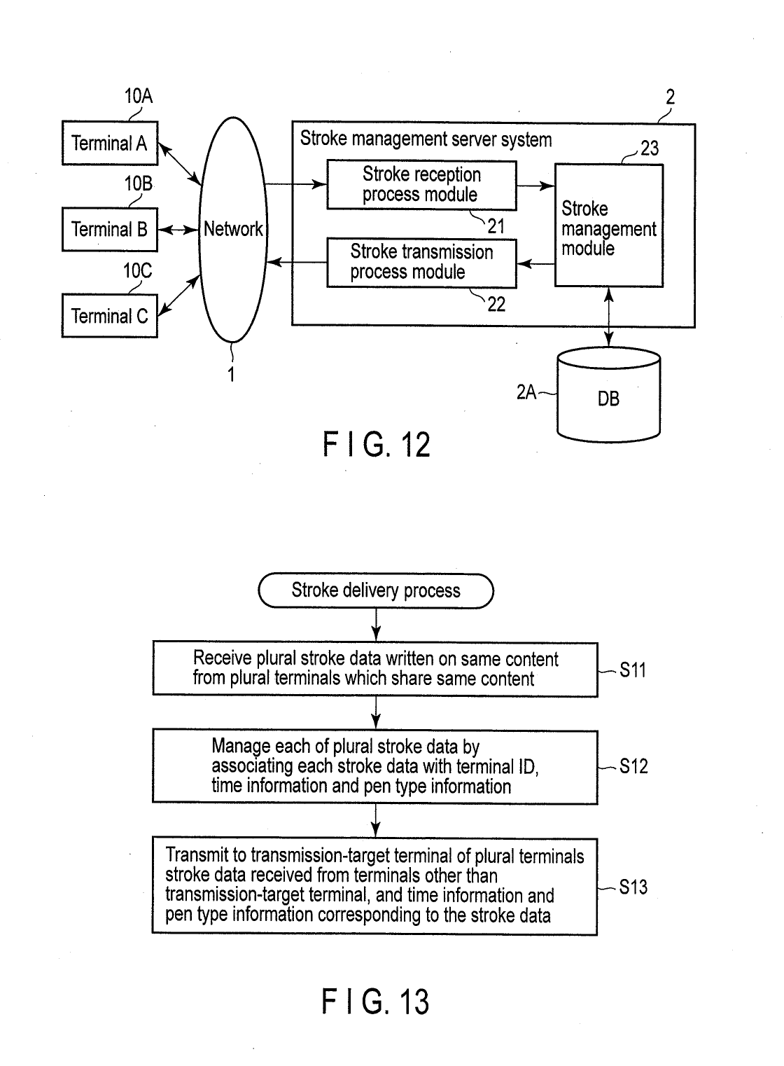

FIG. 12 is an exemplary block diagram illustrating a functional configuration of the stroke management server system 2. The stroke management server system 2 includes a stroke reception process module 21, a stroke transmission process module 22 and a stroke management module 23. The stroke reception process module 21 functions as a receiver configured to receive from the terminals 10A, 10B and 10C a plurality of stroke data corresponding to a plurality of strokes which are handwritten on contents (the same content) in the terminals 10A, 10B and 10C. The stroke management module 23 functions as a controller configured to store in the database 2A (storage medium) the plural received stroke data in the state in which each of the plural received stroke data is associated with the identifier of the terminal that is the sender of each of the plural received stroke data. The stroke transmission process module 22 functions as a transmitter configured to transmit to an arbitrary terminal (first terminal) of the terminals 10A, 10B and 10C one or more first stroke data which have been received from the terminals other than the first terminal. In the database 2A, each stroke data is associated with the terminal ID of the terminal that is the sender of this stroke data. The above-described one or more first stroke data are stroke data which are associated with the terminals ID of the terminals other than the first terminal.

Next, referring to a flowchart of FIG. 13, a description is given of the procedure of a stroke delivery process which is executed by the stroke management server system 2.

The stroke reception process module 21 of the stroke management server system 2 receives from the terminals 10A, 10B and 10C, which share the same content, a plurality of stroke data corresponding to a plurality of strokes which are handwritten on the content by the users A, B and C of the terminals 10A, 10B and 10C (step S11). The stroke management module 23 of the stroke management server system 2 manages each received stroke data by associating the received stroke data with the ID of the terminal which has transmitted this stroke data, time information indicative of the time at which the stroke of the stroke data was handwritten, and the pen type information corresponding to this stroke data (step S12).

The stroke transmission process module 22 of the stroke management server system 2 transmits to a transmission-target terminal of the terminals 10A, 10B and 10C stroke data received from the terminals other than this transmission-target terminal, and the time information and pen type information corresponding to this stroke data (step S13). For example, if the terminal 10A is the transmission-target terminal, the stroke transmission process module 22 transmits to the terminal 10A each stroke data received from the terminal 10B and the time information and pen type information corresponding to this stroke data. Further, the stroke transmission process module 22 transmits to the terminal 10A each stroke data received from the terminal 10C and the time information and pen type information corresponding to this stroke data.

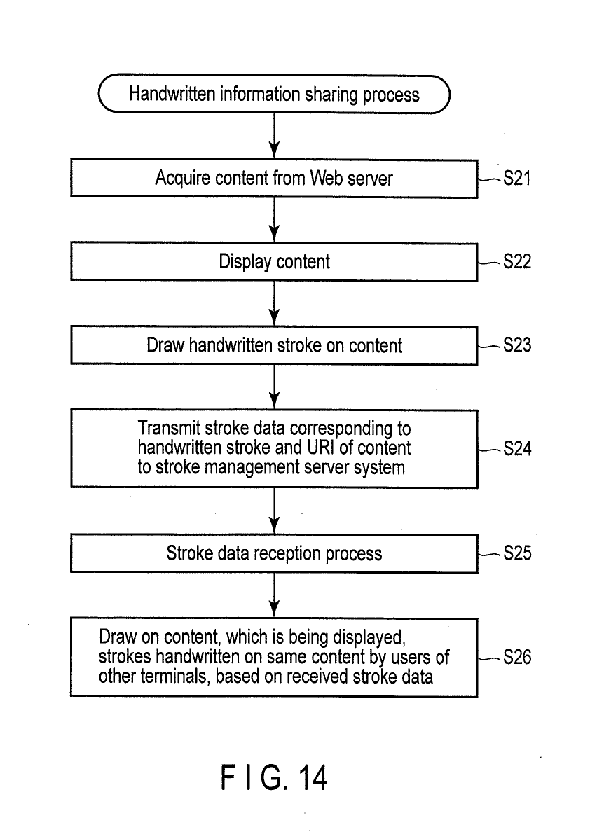

Next, referring to a flowchart of FIG. 14, a description is given of the procedure of a handwritten information sharing process which is executed by the tablet computer 10. Although the handwritten information sharing process will be described by illustrating the case in which the content that is shared between the terminals is a Web page, the content that is shared is not limited to a Web page, and may be arbitrary content such as an electronic book, text data, image data (still image, moving picture), etc.

The handwriting note application program 202 of the tablet computer 10 acquires content, such as a Web page, from the Web server 3 (step S21). Then, by drawing a screen image of the Web page, the handwriting note application program 202 displays the screen image of the Web page on the touch-screen display 17 (step S22). The handwriting note application program 202 draws each stroke, which has been handwritten on the touch-screen display 17 by a handwriting input operation by the user, on the layer 30A on the screen image of the Web page (step S23). Thereby, a handwritten character, etc. is displayed on the Web page (“overlay”).

Then, the handwriting note application program 202 transmits to the stroke management server system 2 a set of the stroke data corresponding to the handwritten stroke and the URI of the Web page (step S24). The transmission of the set of the stroke data and the URI of the Web page is executed in units of one stroke. For example, by periodically executing polling, the handwriting note application program 202 receives, from the stroke management server system 2, the stroke data corresponding to strokes handwritten on the above-described Web page in the other terminals, and the time information of this stroke data (step S25).

The handwriting note application program 202 draws, on the Web page that is being displayed, the same strokes as the strokes handwritten on the above-described Web page in the other terminals (step S26). The drawing of the strokes is performed based on the received stroke data and time information. Thereby, characters, etc. handwritten on the other terminals are displayed on the Web page on the screen of the tablet computer 10.

As has been described above, in the present embodiment, a plurality of stroke data corresponding to a plurality of strokes, which are handwritten on first contents (shared content) in a plurality of terminals 10A, 10B and 10C, are received from these plural terminals 10A, 10B and 10C, and the plural stroke data are is stored in the database (storage medium) 2A. The plural stroke data are associated with the identifier of the terminal that is a sender of the stroke data. Stroke data, which are associated with the identifiers of the terminals other than a first terminal (transmission-target terminal), which is one of the terminals 10A, 10B and 10C, are transmitted to the first terminal (transmission-target terminal). Thereby, handwritten information, which is written on the same content, can be shared between the terminals 10A, 10B and 10C. Thus, for example, in a meeting, handwritten information (handwritten characters, handwritten graphics, etc.), which is written on the same material (content) can easily be exchanged/shared among the participants in the meeting. In addition, both the content and the stroke data are not exchanged between the terminals. Since only the stroke data are exchanged between the terminals, the exchange/sharing of handwritten information can be realized with a relatively small communication data amount.

Furthermore, by transmitting the set of the stroke data and time information to the first terminal, it is possible to reproduce, in the first terminal, the order relation between strokes, such as handwritten characters, which were written in another terminal, and strokes, such as handwritten characters, which were written in still another terminal.

In the present embodiment, the case in which absolute time is used as time information has been described by way of example. However, in the case of content such as a moving picture, it is possible to use, as a time at which a stroke was written, an offset value indicative of an elapsed time from the start of playback of this content.

In addition, in this embodiment, the case in which each terminal acquires content from the server has been described by way of example. Alternatively, content which is stored in a local storage in each terminal may be displayed on the display of each terminal.

An electronic textbook, which can be identified by the same URI, may be distributed to a plurality of terminals, and strokes, which are written by a lecturer during a lecture, may be displayed in real time on the electronic textbook of each terminal. In the case of a lecture, aside from the information of strokes, the relation between the progress of the content of the lecture and the timing, at which strokes are actually written, is important. It is thus effective to transmit the set of stroke data and time information to each terminal.

The process of the stroke management server system 2 of the present embodiment can be realized by a computer program. Thus, the same advantageous effects as with the present embodiment can easily be obtained simply by installing the computer program into a server computer through a computer-readable storage medium which stores the computer program, and executing the computer program.

The process of the tablet computer 10 of the present embodiment can also be realized by a computer program. Thus, the same advantageous effects as with the present embodiment can easily be obtained simply by installing the computer program into an ordinary computer through a computer-readable storage medium which stores the computer program, and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system comprising:
a receiver configured to receive a plurality of stroke data, which correspond to a plurality of strokes handwritten on first contents in a plurality of terminals, from the plurality of terminals;
a controller configured to store the plurality of stroke data in a storage medium, the plurality of stroke data associated with an identifier of a terminal which is a sender; and
a transmitter configured to transmit to a first terminal of the plurality of terminals one or more first stroke data of the plurality of stroke data, the one or more first stroke data being associated with an identifier of a terminal other than the first terminal.

2. The system of claim 1,
wherein the plurality of stroke data are associated with time information corresponding to handwriting timings of the plurality of stroke data, and
wherein the transmitter is further configured to transmit to the first terminal the one or more first stroke data and the time information corresponding to the one or more first stroke data.

3. The system of claim 1, wherein the plurality of stroke data are associated with an identifier corresponding to the first contents.

4. The system of claim 1, wherein each of the plurality of stroke data comprises a thickness or a color of a stroke corresponding to each of the plurality of stroke data.

5. The system of claim 1, wherein the plurality of stroke data includes erase stroke data corresponding to a stroke which is handwritten in an erase mode.

6. The system of claim 1, wherein the transmitter is further configured to determine a terminal from which stroke data is to be provided to the first terminal, in response to a request from the first terminal.

7. A data providing method comprising:
receiving a plurality of stroke data, which correspond to a plurality of strokes handwritten on first contents in a plurality of terminals, from the plurality of terminals;
storing the plurality of stroke data in a storage medium, the plurality of stroke data associated with an identifier of a terminal which is a sender; and
transmitting to a first terminal of the plurality of terminals one or more first stroke data of the plurality of stroke data, the one or more first stroke data being associated with an identifier of a terminal other than the first terminal.

8. A computer-readable, non-transitory storage medium having stored thereon a computer program which is executable by a computer, the program controlling the computer to execute functions of:
receiving a plurality of stroke data, which correspond to a plurality of strokes handwritten on first contents in a plurality of terminals, from the plurality of terminals;
storing the plurality of stroke data in a storage medium, the plurality of stroke data associated with an identifier of a terminal which is a sender; and
transmitting to a first terminal of the plurality of terminals one or more first stroke data of the plurality of stroke data, the one or more first stroke data being associated with an identifier of a terminal other than the first terminal.

9. An electronic apparatus comprising:
a transmitter configured to transmit to a system first stroke data corresponding to a first stroke which is handwritten on first content displayed on a display of the electronic apparatus;
a receiver configured to receive from the system second stroke data corresponding to a second stroke which is handwritten on first content displayed on a display of another terminal; and
a drawing process module configured to draw the second stroke on the first content displayed on the display of the electronic apparatus, based on the second stroke data.
